(19) United States
(12) Patent Application Publication
(10) Pub. No.: US 2009/0046027 A1
(43) Pub. Date: Feb. 19, 2009

(54) COUPLING DEVICE

(75) Inventors: Yi-Cheng Lin, Taipei City (TW); Kuo-Fong Hung, Taipei City (TW)

Correspondence Address: QUINTERO LAW OFFICE, PC, 2210 MAIN STREET, SUITE 200, SANTA MONICA, CA, 90405, US

(73) Assignee: NATIONAL TAIWAN UNIVERSITY, Taipei (TW)

(21) Appl. No.: 12/190,559

(22) Filed: Aug. 12, 2008

(30) Foreign Application Priority Data
Aug. 13, 2007 (TW) TW96129824

(51) Int. Cl. H01Q 15/24

(52) U.S. Cl. 343/756

(57) ABSTRACT

A coupling device is provided, including a substrate, a ground element, a first feed conductor and a second feed conductor. The substrate includes a first surface and a second surface. The ground element is disposed on the second surface, wherein the ground element includes a first portion, a second portion, an annular groove and a feed slot, the annular groove is located between the first portion and the second portion, enclosing the first portion, and a first end of the feed slot is connected to the annular groove. The first feed conductor is disposed on the first surface corresponding to the annular groove, wherein the first feed conductor couples the ground element to feed a current signal. The second feed conductor is disposed on the first surface corresponding to the feed slot, wherein second feed conductor couples the feed slot to feed a magnetic fluid signal.

### BACKGROUND OF THE INVENTION

1. Field of the Invention

The invention relates to a coupling device, and more particularly to a coupling device with improved isolation.

2. Description of the Related Art

FIG. 1 shows a conventional coupling antenna 1 comprising a substrate 10, a ground element 20, a first feed conductor 30 and a second feed conductor 40. The substrate 10 comprises a first surface 11 and a second surface 12. The ground element 20 is disposed on the second surface 12, which comprises a first portion 21, a second portion 22 and an annular groove 23. The annular groove 23 is located between the first portion 21 and the second portion 22 enclosing the first portion 21. The first feed conductor 30 is disposed on the first surface 11 corresponding to the first portion 21 and the annular groove 23. The second feed conductor 40 is disposed on the first surface 11 corresponding to the first portion 21 and the annular groove 23.

When a conventional coupling antenna 1 is utilized for transmitting wireless signal, noise is generated due to poor isolation between the first feed conductor 30 and the second feed conductor 40.

### BRIEF SUMMARY OF THE INVENTION

A detailed description is given in the following embodiments with reference to the accompanying drawings.

A coupling device is provided, comprising a substrate, a ground element, a first feed conductor and a second feed conductor. The substrate comprises a first surface and a second surface. The ground element is disposed on the second surface, wherein the ground element comprises a first portion, a second portion, an annular groove and a feed slot, the annular groove is located between the first portion and the second portion, enclosing the first portion, and a first end of the feed slot is connected to the annular groove. The first feed conductor is disposed on the first surface corresponding to the annular groove, wherein the first feed conductor couples the ground element to feed a current signal. The second feed conductor is disposed on the first surface corresponding to the feed slot, wherein second feed conductor couples the feed slot to feed a magnetic fluid signal.

The coupling device of the invention provides improved port isolation and polarization isolation.

### BRIEF DESCRIPTION OF THE DRAWINGS

The invention can be more fully understood by reading the subsequent detailed description and examples with references made to the accompanying drawings, wherein:

FIG. 1 shows a conventional coupling antenna;

FIG. 2 shows a coupling device of the invention;

FIG. 3 is a top view of the coupling device of the invention;

FIG. 4a shows location of a first radiation area of the invention;

FIG. 4b shows location of a second radiation area of the invention;

FIG. 5 shows signal reflection of the coupling device of the invention;

FIG. 6a shows divergence field on x-z plane of the first feed conductor of the invention;

FIG. 6b shows divergence field on y-z plane of the first feed conductor of the invention;

FIG. 7a shows divergence field on x-z plane of the second feed conductor of the invention; and

FIG. 7b shows divergence field on y-z plane of the second feed conductor of the invention.

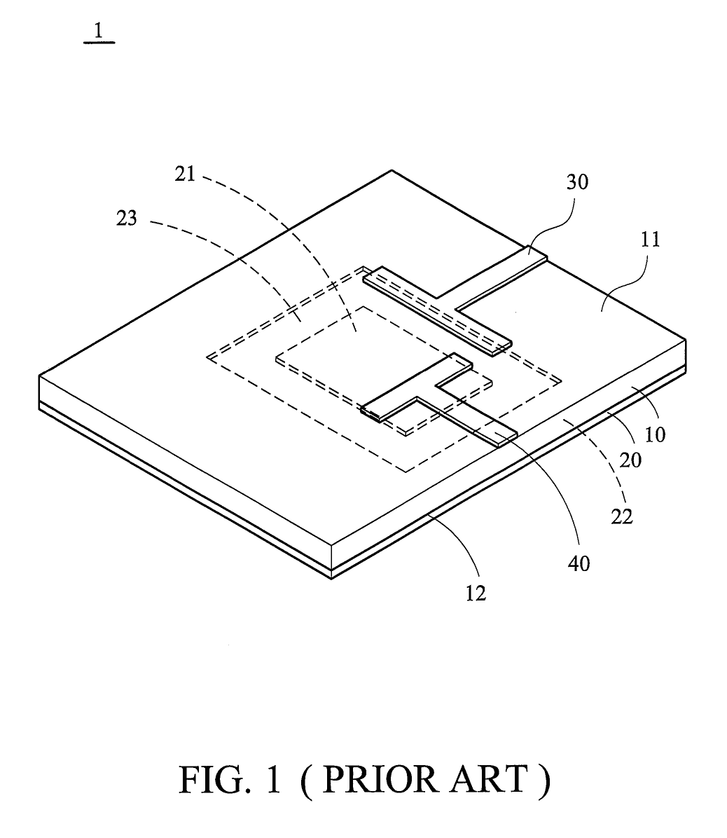

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

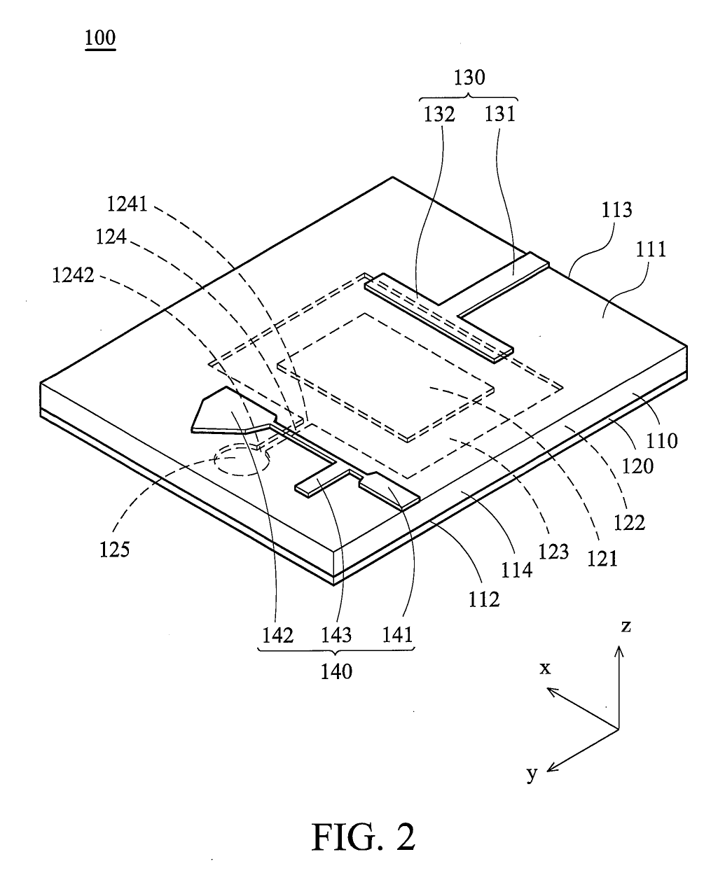

FIG. 2 shows a coupling device 100 of the invention which comprises a substrate 110, a ground element 120, a first feed conductor 130 and a second feed conductor 140. The substrate 110 comprises a first surface 111 and a second surface 112. The ground element 120 is disposed on the second surface 112. The first feed conductor 130 and the second feed conductor 140 are disposed on the first surface 111 corresponding to the ground element 120.

The ground element 120 comprises a first portion 121, a second portion 122, an annular groove 123, a feed slot 124 and a short slot 125. The annular groove 123 is located between the first portion 121 and the second portion 122 enclosing the first portion 121. The first portion 121 is rectangular. The annular groove 123 defines a rectangular area. A first end 1241 of the feed slot 124 is connected to the annular groove 123. A second end 1242 of the feed slot 124 is connected to the short slot 125. The short slot 125 is circular.

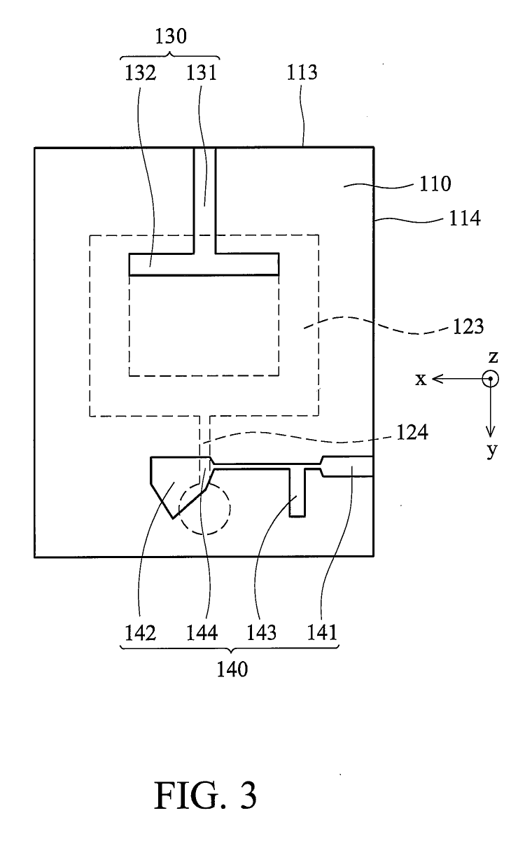

With reference to FIG. 3, the substrate 110 further comprises a first side 113 and a second side 114. The first side 113 is perpendicular to the second side 114. The feed conductor 130 extends in a first direction y from the first side 113. The second feed conductor 140 extends in a second direction x from the second side 114. The first direction y is perpendicular to the second direction x.

The first feed conductor 130 is T-shaped, comprising a first conductive portion 131 and a first feed portion 132. The first feed portion 132 corresponds to the annular groove 123. The first conductive portion 131 extends in the first direction y from the first side 113 connected to the first feed portion 132. The first conductive portion 131 is perpendicular to the first feed portion 132.

With reference to FIGS. 2 and 3, the second feed conductor 140 comprises a second conductive portion 141, a second feed portion 142 and a matching element 143. The second feed portion 142 corresponds to the feed slot 124. The second conductive portion 141 extends in the second direction x from the second side 114 connected to the second feed portion 142. The second feed portion 142 is substantially sector-shaped, and comprises a convergent end 144. The second conductive portion 141 is connected to the convergent end 144, and the convergent end 144 corresponds to the second end 1242 of the feed slot 124. An included angle nearing the convergent end 144 is between 0° to 90°. The matching element 143 connects the second conductive portion 141 and is perpendicular thereto.

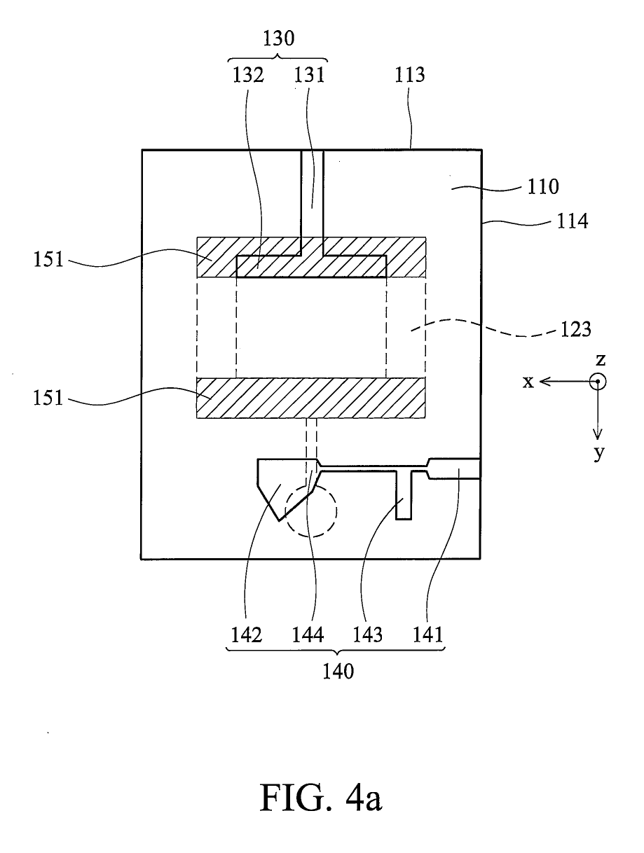

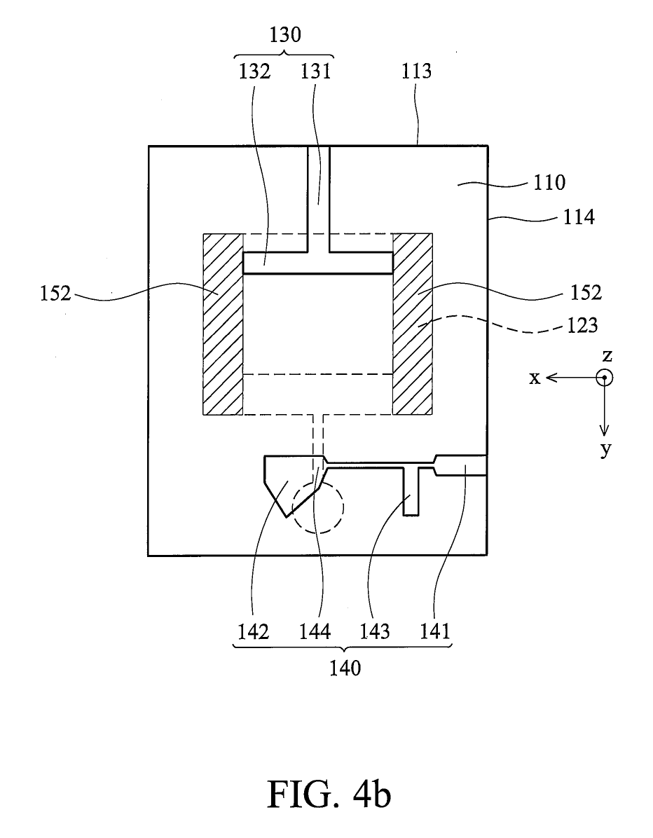

When the coupling device 100 transmits a wireless signal, the first feed conductor 130 couples the ground element 120 to feed a current signal, and the second feed conductor 140 couples the feed slot 124 to feed a magnetic fluid signal. With reference to FIG. 4a, after the first feed conductor 130 couples the ground 120 to feed the current signal, the coupling device 100 transmits a first wireless signal via a first radiation area 151. With reference to FIG. 4b, after the second feed conductor 140 couples the feed slot 124 to feed the magnetic fluid signal, the coupling device 100 transmits a second wireless signal via a second radiation area 152. A polarization mode of the first radiation area 151 is perpendicular to a polarization mode of the second radiation area 152. A polarization direction of the first wireless signal is perpendicular to a polarization direction of the second wireless signal.

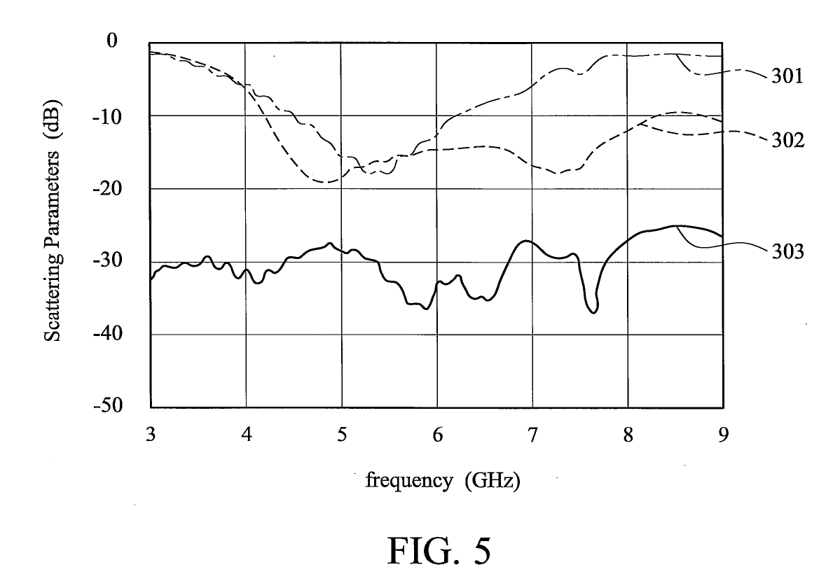

FIG. 5 shows signal reflection of the coupling device 100 of the invention, wherein curve 301 shows a return loss (S11) of a first output port, curve 302 shows a return loss (S22) of a second output port, and curve 303 shows isolation (S21) between the first output port and the second output port. As shown in FIG. 5, scattering parameter of the curve 303 is substantially lower than −25 dB. The coupling device 100 of the invention provides improved port isolation.

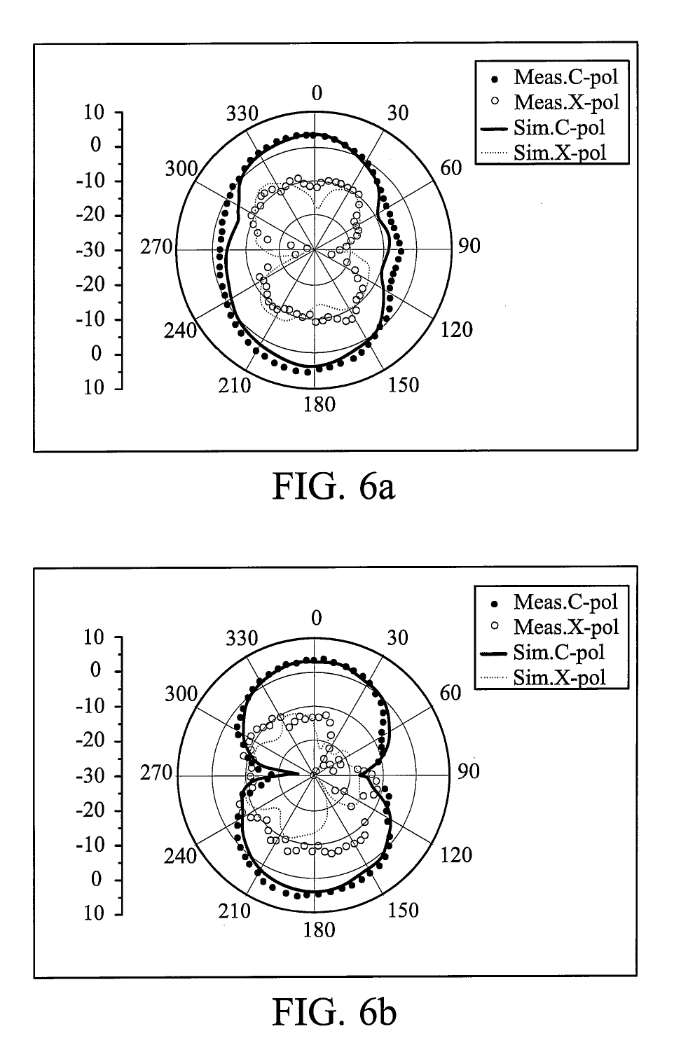

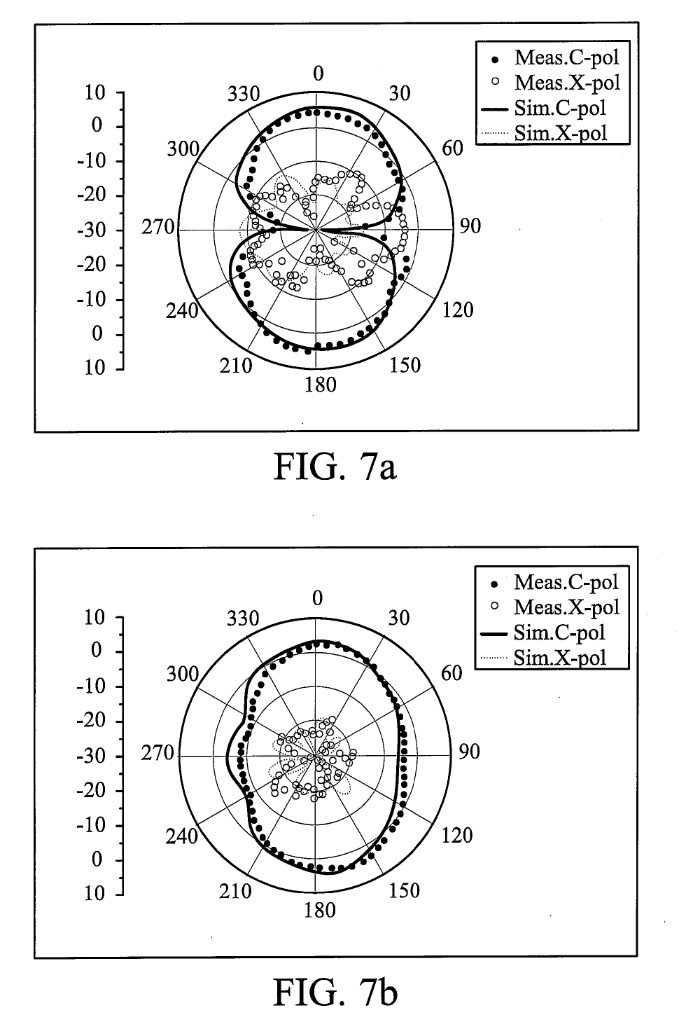

FIG. 6a shows divergence field on x-z plane of the first feed conductor 130 of the invention, FIG. 6b shows divergence field on y-z plane of the first feed conductor 130 of the invention, FIG. 7a shows divergence field on x-z plane of the second feed conductor 140 of the invention, and FIG. 7b shows divergence field on y-z plane of the second feed conductor 140 of the invention. As shown in FIGS. 6a, 6b, 7a and 7b, the coupling device 100 of the invention also provides improved polarization isolation.

In the embodiment of the invention, the shape and location of the first feed conductor 130 and the second feed conductor 140 can be modified according to matching requirement.

The coupling device of the invention can be a feed assembly mechanism of a dual-polarized antenna or an orthomode transducer of a wave guide.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A coupling device, comprising:
a substrate, comprising a first surface and a second surface;
a ground element, disposed on the second surface, wherein the ground element comprises a first portion, a second portion, an annular groove and a feed slot, the annular groove is located between the first portion and the second portion, enclosing the first portion, and a first end of the feed slot is connected to the annular groove;
a first feed conductor, disposed on the first surface corresponding to the annular groove, wherein the first feed conductor couples the ground element to feed a current signal; and
a second feed conductor, disposed on the first surface corresponding to the feed slot, wherein second feed conductor couples the feed slot to feed a magnetic fluid signal.

2. The coupling device as claimed in claim 1, wherein the substrate further comprises a first side and a second side, the first side is perpendicular to the second side, the first feed conductor extends in a first direction from the first side, the second feed conductor extends in a second direction from the second side, and the first direction is perpendicular to the second direction.

3. The coupling device as claimed in claim 1, wherein the first feed conductor comprises a first conductive portion and a first feed portion, the first feed portion corresponds to the annular groove, and the first conductive extends in the first direction from the first side connected to the first feed portion.

4. The coupling device as claimed in claim 3, wherein the first feed conductor is T-shaped, and the first conductive portion is perpendicular to the first feed portion.

5. The coupling device as claimed in claim 1, wherein the ground element further comprises a short slot connecting a second end of the feed slot.

6. The coupling device as claimed in claim 5, wherein the short slot is circular.

7. The coupling device as claimed in claim 2, wherein the second feed conductor comprises a second conductive portion and a second feed portion, the second feed portion corresponds to the feed slot, and the second conductive extends in the second direction from the second side connected to the second feed portion.

8. The coupling device as claimed in claim 7, wherein the second feed portion is substantially sector-shaped, and comprises a convergent end connected to the second conductive portion.

9. The coupling device as claimed in claim 8, wherein the ground element further comprises a short slot connecting a second of the feed slot, and the convergent end corresponds to the second end.

10. The coupling device as claimed in claim 7, wherein the second feed conductor further comprises a matching element connected to the second conductive portion and is perpendicular thereto.

11. The coupling device as claimed in claim 1, wherein the first portion is rectangular.

12. The coupling device as claimed in claim 1, wherein the annular groove defines a rectangular area.

13. The coupling device as claimed in claim 1, wherein the first feed conductor transmits a first wireless signal, the second feed conductor transmits a second wireless signal, and a polarization direction of the first wireless signal is perpendicular to a polarization direction of the second wireless signal.

14. The coupling device as claimed in claim 1, wherein the coupling device is a feed assembly mechanism of a dual-polarized antenna.

15. The coupling device as claimed in claim 1, wherein the coupling device is an orthomode transducer of a wave guide.
